(19) United States
(12) Patent Application Publication
(10) Pub. No.: US 2008/0252151 A1
(43) Pub. Date: Oct. 16, 2008

(54) TWO DEGREE OF FREEDOM MOVERS WITH OVERLAPPING COILS

(75) Inventors: Michael B. Binnard, Belmont, CA (US); Masahiro Totsu, Kumagaya (JP)

Correspondence Address: Roeder & Broder LLP, 5560 Chelsea Avenue, La Jolla, CA, 92037, US

(73) Assignee: Nikon Corporation, Tokyo (JP)

(21) Appl. No.: 12/061,428

(22) Filed: Apr. 2, 2008

Related U.S. Application Data
(60) Provisional application No. 60/921,801, filed on Apr. 3, 2007.

(51) Int. Cl. H02K 41/00

(52) U.S. Cl. 310/12

(57) ABSTRACT

A mover (344) that moves a stage (238) along a first axis and along a second axis includes a magnetic component (354), a conductor component (356), and a control system (324). The magnetic component (354) includes one or more magnets (354D) that are surrounded by a magnetic field. The conductor component (356) is positioned near the magnetic component (354). Further, the conductor component (356) interacts with the magnetic component (354) when current is directed to the conductor component (356). The control system (224) directs current to the conductor component (356) to generate a controllable force along the first axis and a controllable force along the second axis. With this design, the same mover (344) can be used to move the stage (238) along two degrees of freedom (“DOF”). Further, the conductor component (356) including a first phase coil (364A) and a second phase coil (364B) that partly overlaps the first phase coil (364A). With this design, the size and efficiency of the mover (334) is significantly improved. As a result thereof, the overall footprint of the mover (344) can be reduced and the heat generated by the mover (344) is minimized.

### RELATED APPLICATION

This application claims priority on U.S. Provisional Application Ser. No. 60/921,801 filed on Apr. 3, 2007 and entitled “TWO DEGREE OF FREEDOM MOTORS”. The contents of U.S. Provisional Application Ser. No. 60/921,801 are incorporated herein by reference.

### BACKGROUND

Exposure apparatuses for semiconductor processing are commonly used to transfer images from a reticle onto a semiconductor wafer during semiconductor processing. A typical exposure apparatus includes an illumination source, a reticle stage assembly that positions a reticle, an optical assembly, a wafer stage assembly that positions a semiconductor wafer, a measurement system, and a control system. For many exposure apparatuses, space is often a premium. Thus, it is often desirable to make many of the components of the exposure apparatus as compact and efficient as possible.

One type of stage assembly includes a stage base, a stage that retains the wafer or reticle, and one or more movers that move the stage and the wafer or the reticle. One type of mover is a linear motor that moves the stage along a single axis. Because, it is often necessary to move the stage along more than one axis, multiple linear motors are typically required to move the stage with more than one degree of freedom. These multiple linear motors can complicate the design of the stage assembly and occupy a significant amount of space in the exposure apparatus.

Another type of motor used in stages is a planar motor that can be controlled to move the stage with three degrees of freedom. Unfortunately, planar motor are generally more complicated to control than linear motors. Further, since many systems are arranged to use linear motors, the use of a planar motor instead of one or more linear motors may be impractical.

Two Degree of Freedom (2DOF) motors have been proposed in U.S. Publication No. 2006/0221323 and in U.S. Publication No. 2006/0232142. These applications disclose linear motors that can also produce force in an orthogonal direction. Unfortunately, the designs for the motors disclosed in these applications are not as efficient as possible. In the future, as throughput (acceleration) and accuracy requirements for exposure machines increase, it may become necessary to use more efficient 2DOF linear motors.

As a result thereof, existing movers for stages are not entirely satisfactory.

### SUMMARY

The present invention is directed a mover that moves a stage along a first axis and along a second axis. The mover includes a magnetic component, a conductor component, and a control system. The magnetic component includes one or more magnets that produce a magnetic field. The conductor component is positioned near the magnetic component. Further, the conductor component interacts with the magnetic field when current is directed to the conductor component. The control system directs current to the conductor component to generate a controllable force along the first axis and a controllable force along the second axis. With this design, the same mover can be used to move the stage along two degrees of freedom (“DOF”).

Further, as provided herein, the conductor component including a first phase coil and a second phase coil that partly overlaps the first phase coil. With this design, the size and efficiency of the mover is significantly improved. As a result thereof, the overall footprint of the mover can be reduced and the heat generated by the mover is minimized. Further, because of the increased efficiency, the mover can produce larger forces (and therefore higher stage acceleration) with less thermal disturbance (heat) to the rest of the system.

In one embodiment, the first phase coil includes a pair of spaced apart first coil legs, and the second phase coil includes a pair of spaced apart second coil legs. In this embodiment, one of the first coil legs is positioned between second coil legs.

Additionally, the coil assembly can include a third phase coil that partly overlaps the first phase coil and the second phase coil. In this embodiment, one of the second coil legs and one of the third coil legs are positioned between the first coil legs.

Further, in certain embodiments, each of the phase coils can have a split coil design.

Moreover, in one embodiment, the magnetic component includes a pair of spaced apart magnet arrays and the conductor component is positioned between the magnet arrays. In another design, the magnetic component includes a single magnet array that is positioned on one side of the conductor component. It is also possible to have a pair of spaced apart conductor arrays with a magnet array positioned between the conductor arrays.

Further, the present invention is also directed to a stage assembly, an exposure apparatus, a method for moving a stage, a method for manufacturing an exposure apparatus, and a method for manufacturing an object or a wafer.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a schematic illustration of an exposure apparatus having features of the present invention;

FIG. 2 is a simplified top perspective view of a stage assembly having features of the present invention;

FIG. 3A is a simplified perspective view of one embodiment of a mover having features of the present invention;

FIG. 3B is a simplified cut-away view of a portion of the mover of FIG. 3A and a control system;

FIG. 3C is a simplified perspective view of three coils from the mover of FIG. 3A;

FIG. 3D is a simplified, exploded perspective view of the three coils from FIG. 3C;

FIG. 4A is a simplified perspective view of another embodiment of a mover having features of the present invention;

FIG. 4B is a simplified cut-away view of a portion of the mover of FIG. 4A and a control system;

FIG. 4C is a simplified, exploded perspective view of the three coils from FIG. 4A;

FIG. 5 is a simplified cut-away view of a portion of another mover having features of the present invention;

FIG. 6 is a side view of another embodiment of a coil assembly having features of the present invention;

FIG. 7 is a perspective view of yet another embodiment of a coil assembly having features of the present invention;

FIG. 8A is a flow chart that outlines a process for manufacturing a device in accordance with the present invention; and

FIG. 8B is a flow chart that outlines device processing in more detail.

### DESCRIPTION

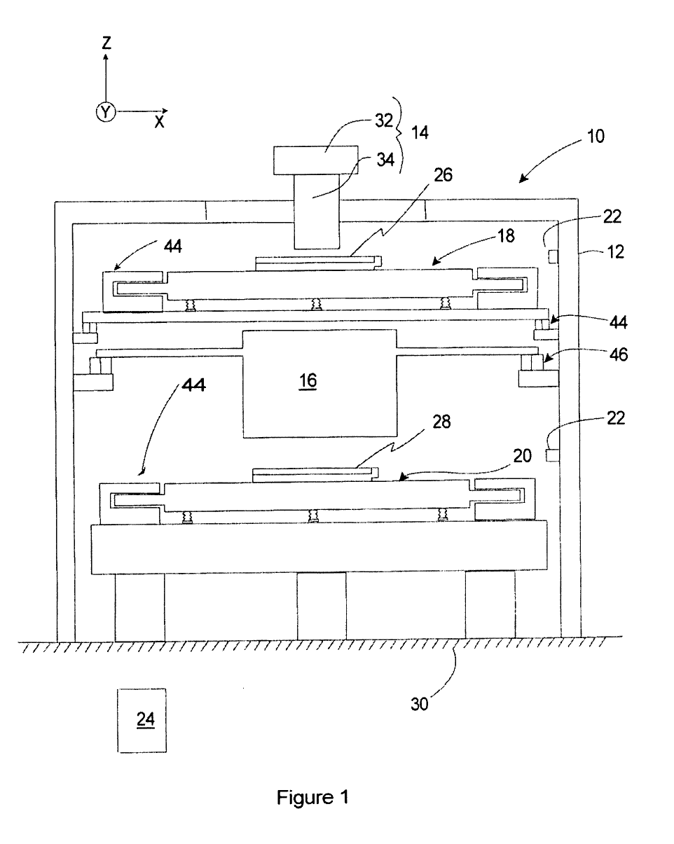

FIG. 1 is a schematic illustration of a precision assembly, namely an exposure apparatus 10 having features of the present invention. The exposure apparatus 10 includes an apparatus frame 12, an illumination system 14 (irradiation apparatus), an optical assembly 16, a reticle stage assembly 18, a wafer stage assembly 20, a measurement system 22, and a control system 24. The design of the components of the exposure apparatus 10 can be varied to suit the design requirements of the exposure apparatus 10.

As an overview, in certain embodiments, one or both of the stage assemblies 18, 20 include one or more, two DOF movers 44 that are uniquely designed to provide an efficient, non-zero net force along at least two axes while still being relatively simple to operate. Further, the two DOF movers 44 have a size and shape that is somewhat similar to that of existing linear motors. As a result thereof, the two DOF movers 44 can be implemented in most stage assemblies 18, 20 without extensive changes to the design of the stage assemblies 18, 20. Moreover, this configuration allows for the movement along an additional axis without taking up additional space and without requiring additional movers.

A number of Figures include an orientation system that illustrates an X axis, a Y axis that is orthogonal to the X axis and a Z axis that is orthogonal to the X and Y axes. It should be noted that any of these axes can also be referred to as the first, second, and/or third axes. In general, there are six degrees of freedom, including translation along the X, Y and Z axes and rotation about the X, Y and Z axes.

The exposure apparatus 10 is particularly useful as a lithographic device that transfers a pattern (not shown) of an integrated circuit from a reticle 26 onto a semiconductor wafer 28. The exposure apparatus 10 mounts to a mounting base 30, e.g., the ground, a base, or floor or some other supporting structure.

There are a number of different types of lithographic devices. For example, the exposure apparatus 10 can be used as a scanning type photolithography system that exposes the pattern from the reticle 26 onto the wafer 28 with the reticle 26 and the wafer 28 moving synchronously. In a scanning type lithographic device, the reticle 26 is moved perpendicularly to an optical axis of the optical assembly 16 by the reticle stage assembly 18 and the wafer 28 is moved perpendicularly to the optical axis of the optical assembly 16 by the wafer stage assembly 20. Scanning of the reticle 26 and the wafer 28 occurs while the reticle 26 and the wafer 28 are moving synchronously.

Alternatively, the exposure apparatus 10 can be a step-and-repeat type photolithography system that exposes the reticle 26 while the reticle 26 and the wafer 28 are stationary. In the step and repeat process, the wafer 28 is in a constant position relative to the reticle 26 and the optical assembly 16 during the exposure of an individual field. Subsequently, between consecutive exposure steps, the wafer 28 is consecutively moved with the wafer stage assembly 20 perpendicularly to the optical axis of the optical assembly 16 so that the next field of the wafer 28 is brought into position relative to the optical assembly 16 and the reticle 26 for exposure. Following this process, the images on the reticle 26 are sequentially exposed onto the fields of the wafer 28, and then the next field of the wafer 28 is brought into position relative to the optical assembly 16 and the reticle 26.

However, the use of the exposure apparatus 10 provided herein is not limited to a photolithography system for semiconductor manufacturing. The exposure apparatus 10, for example, can be used as an LCD photolithography system that exposes a liquid crystal display device pattern onto a rectangular glass plate or a photolithography system for manufacturing a thin film magnetic head. Further, the present invention can also be applied to a proximity photolithography system that exposes a mask pattern from a mask to a substrate with the mask located close to the substrate without the use of a lens assembly.

The apparatus frame 12 is rigid and supports the components of the exposure apparatus 10. The apparatus frame 12 illustrated in FIG. 1 supports the reticle stage assembly 18, the optical assembly 16 and the illumination system 14 above the mounting base 30.

The illumination system 14 includes an illumination source 32 and an illumination optical assembly 34. The illumination source 32 emits a beam (irradiation) of light energy. The illumination optical assembly 34 guides the beam of light energy from the illumination source 32 to the optical assembly 16. The beam illuminates selectively different portions of the reticle 26 and exposes the wafer 28. In FIG. 1, the illumination source 32 is illustrated as being supported above the reticle stage assembly 18. Typically, however, the illumination source 32 is secured to one of the sides of the apparatus frame 12 and the energy beam from the illumination source 32 is directed to above the reticle stage assembly 18 with the illumination optical assembly 34.

The illumination source 32 can be a g-line source (436 nm), an i-line source (365 nm), a KrF excimer laser (248 nm), an ArF excimer laser (193 nm) or a F₂ laser (157 nm). Alternatively, the illumination source 32 can generate charged particle beams such as an x-ray or an electron beam. For instance, in the case where an electron beam is used, thermionic emission type lanthanum hexaboride (LaB₆) or tantalum (Ta) can be used as a cathode for an electron gun. Furthermore, in the case where an electron beam is used, the structure could be such that either a mask is used or a pattern can be directly formed on a substrate without the use of a mask.

The optical assembly 16 projects and/or focuses the light passing through the reticle 26 to the wafer 28. Depending upon the design of the exposure apparatus 10, the optical assembly 16 can magnify or reduce the image illuminated on the reticle 26. The optical assembly 16 need not be limited to a reduction system. It could also be a 1× or magnification system.

When far ultra-violet rays such as the excimer laser is used, glass materials such as quartz and fluorite that transmit far ultra-violet rays can be used in the optical assembly 16. When the F₂ type laser or x-ray is used, the optical assembly 16 can be either catadioptric or refractive (a reticle should also preferably be a reflective type), and when an electron beam is used, electron optics can consist of electron lenses and deflectors. The optical path for the electron beams should be in a vacuum.

Also, with an exposure device that employs vacuum ultra-violet radiation (VUV) of wavelength 200 nm or lower, use of the catadioptric type optical system can be considered. Examples of the catadioptric type of optical system include the disclosure Japan Patent Application Disclosure No. 8-171054 published in the Official Gazette for Laid-Open Patent Applications and its counterpart U.S. Pat. No. 5,668,672, as well as Japan Patent Application Disclosure No. 10-20195 and its counterpart U.S. Pat. No. 5,835,275. In these cases, the reflecting optical device can be a catadioptric optical system incorporating a beam splitter and concave mirror. Japan Patent Application Disclosure No. 8-334695 published in the Official Gazette for Laid-Open Patent Applications and its counterpart U.S. Pat. No. 5,689,377 as well as Japan Patent Application Disclosure No. 10-3039 and its counterpart U.S. Pat. No. 873,605 (Application Date: 6-12-97) also use a reflecting-refracting type of optical system incorporating a concave mirror, etc., but without a beam splitter, and can also be employed with this invention. As far as is permitted, the disclosures in the above-mentioned U.S. patents, as well as the Japan patent applications published in the Official Gazette for Laid-Open Patent Applications are incorporated herein by reference.

The reticle stage assembly 18 holds and positions the reticle 26 relative to the optical assembly 16 and the wafer 28. Somewhat similarly, the wafer stage assembly 20 holds and positions the wafer 28 with respect to the projected image of the illuminated portions of the reticle 26.

Further, in photolithography systems, when linear motors (see U.S. Pat. Nos. 5,623,853 or 5,528,118) are used in a wafer stage or a mask stage, the linear motors can be either an air levitation type employing air bearings or a magnetic levitation type using Lorentz force or reactance force. Additionally, the stage could move along a guide, or it could be a guideless type stage that uses no guide. As far as is permitted, the disclosures in U.S. Pat. Nos. 5,623,853 and 5,528,118 are incorporated herein by reference.

Alternatively, one of the stages could be driven by a planar motor, which drives the stage by an electromagnetic force generated by a magnet unit having two-dimensionally arranged magnets and an armature coil unit having two-dimensionally arranged coils in facing positions. With this type of driving system, either the magnet unit or the armature coil unit is connected to the stage and the other unit is mounted on the moving plane side of the stage.

Movement of the stages as described above generates reaction forces that can affect performance of the photolithography system. Reaction forces generated by the wafer (substrate) stage motion can be mechanically transferred to the floor (ground) by use of a frame member as described in U.S. Pat. No. 5,528,100 and published Japanese Patent Application Disclosure No. 8-136475. Additionally, reaction forces generated by the reticle (mask) stage motion can be mechanically transferred to the floor (ground) by use of a frame member as described in U.S. Pat. No. 5,874,820 and published Japanese Patent Application Disclosure No. 8-330224. As far as is permitted, the disclosures in U.S. Pat. Nos. 5,528,100 and 5,874,820 and Japanese Patent Application Disclosure No. 8-330224 are incorporated herein by reference.

The measurement system 22 monitors movement of the reticle 26 and the wafer 28 relative to the optical assembly 16 or some other reference. With this information, the control system 24 can control the reticle stage assembly 18 to precisely position the reticle 26 and the wafer stage assembly 20 to precisely position the wafer 28. For example, the measurement system 22 can utilize multiple laser interferometers, encoders, and/or other measuring devices.

The control system 24 is connected to the reticle stage assembly 18, the wafer stage assembly 20, and the measurement system 22. The control system 24 receives information from the measurement system 22 and controls the stage mover assemblies 18, 20 to precisely position the reticle 26 and the wafer 28. The control system 24 can include one or more processors and circuits.

A photolithography system (an exposure apparatus) according to the embodiments described herein can be built by assembling various subsystems, including each element listed in the appended claims, in such a manner that prescribed mechanical accuracy, electrical accuracy, and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes mechanical interfaces, electrical circuit wiring connections and air pressure plumbing connections between each subsystem. Needless to say, there is also a process where each subsystem is assembled prior to assembling a photolithography system from the various subsystems. Once a photolithography system is assembled using the various subsystems, a total adjustment is performed to make sure that accuracy is maintained in the complete photolithography system. Additionally, it is desirable to manufacture an exposure system in a clean room where the temperature and cleanliness are controlled.

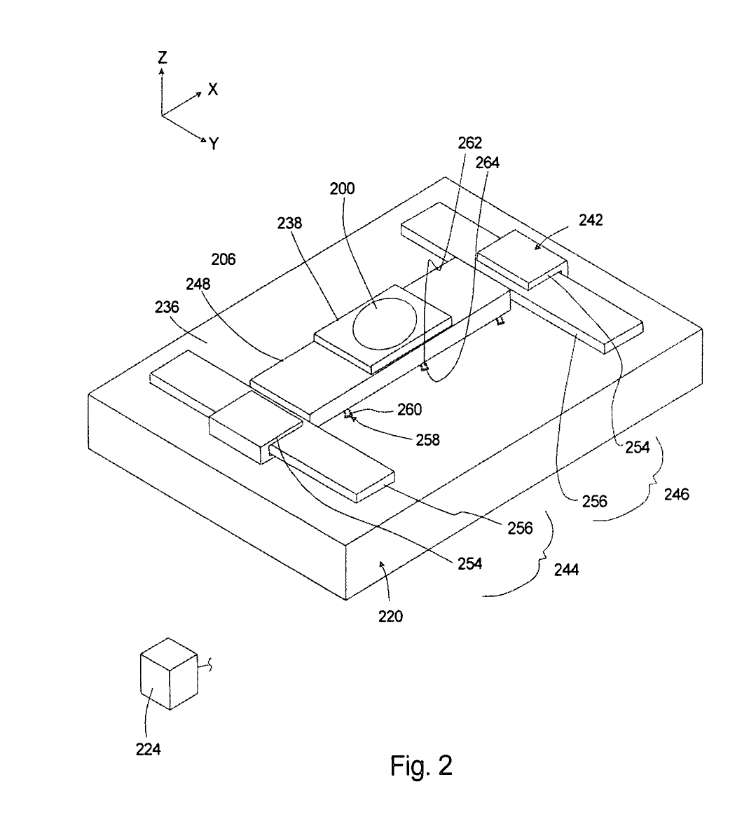

FIG. 2 is a simplified top perspective of a mover assembly 235 that includes a control system 224 and one embodiment of a stage assembly 220 that is used to position a work piece 200. For example, the stage assembly 220 can be used as the wafer stage assembly 20 in the exposure apparatus 10 of FIG. 1. In this embodiment, the stage assembly 220 would position the wafer 28 (illustrated in FIG. 1) during manufacturing of the semiconductor wafer 28. Alternatively, the stage assembly 220 can be used to move other types of work pieces 200 during manufacturing and/or inspection, to move a device under an electron microscope (not shown), or to move a device during a precision measurement operation (not shown). For example, the stage assembly 220 could be designed to function as the reticle stage assembly 18 (illustrated in FIG. 1).

In one embodiment, the stage assembly 220 includes a stage base 236, a stage 238, and a stage mover assembly 242 that includes a pair of two DOF movers 244, 246 that provide an efficient non-zero net force along at least two axes while still being relatively simple to operate. The control system 224 precisely controls the stage mover assembly 242 to precisely position the work piece 200. The size, shape, and design of each these components can be varied pursuant to the teachings provided herein.

In FIG. 2, the stage base 236 supports some of the components of the stage assembly 220. In this embodiment, the stage base 236 is generally rectangular shaped.

The stage 238 retains the work piece 200. In one embodiment, the stage 238 is generally rectangular shaped and includes a chuck (not shown) for holding the work piece 200.

The stage mover assembly 242 moves and positions the stage 238. In FIG. 2, the stage mover assembly 242 moves the stage 238 along the Y axis, along the Z axis, about the Y axis, and about the Z axis. In this embodiment, each of the movers 244, 246 moves along the Y axis and along the Z axis. With this design, the movers 244, 246 can cooperate to move the stage 238 along the Y axis, along the Z axis, about the Y axis, and about the Z axis. Alternatively, for example, the stage mover assembly 242 could be designed to move the stage 238 with more than four degrees of freedom, or less than four degrees of freedom. In FIG. 2, the stage mover assembly 242 includes a first mover 244, a spaced apart second mover 246, and a connector bar 248 that extends between the mover assemblies 244, 246.

The design of each mover 244, 246 can be varied to suit the movement requirements of the stage mover assembly 242. In FIG. 2, each of the movers 244, 246 includes a first mover component 254 and a second mover component 256 that interacts with the first mover component 254. In this embodiment, each of the movers 244, 246 is a two DOF motor and one of the mover components 254, 256 is a magnet component that includes one or more magnets, and one of the mover components 256, 254 is a conductor component that includes one or more conductors, e.g. coils.

In FIG. 2, for each mover 244, 246, the first mover component 254 is coupled to the stage base 236 and the second mover component 256 is secured to the connector bar 248. Alternatively, for example, the first mover component 254 of one or more of the moves 244, 246 can be secured to a counter/reaction mass or a reaction frame as described below.

The design of the movers 244, 246 is described in more detail below.

The connector bar 248 supports the stage 238 and is moved by the movers 244, 246. In FIG. 2, the connector bar 248 is somewhat rectangular beam shaped.

Additionally, in the embodiment illustrated in FIG. 2, the stage assembly 220 includes a fluid bellows assembly 258 that is used to support the dead weight of the connector bar 248, the stage 238 and the work piece 200 along the Z axis. With this design, the fluid bellows assembly 258 can support these components along the Z axis, while the movers 244, 266 can be used to finely adjust the position of the connector bar 248, the stage 238 and the work piece 200 along the Z axis and about the Y axis. This saves power because the movers 244, 266 do not have to be controlled to support the weight of these components. Alternatively, the stage assembly 220 could be designed without the fluid bellows assembly 258.

The design of fluid bellows assembly 258 can vary. In one embodiment, the fluid bellows assembly 258 includes a plurality of spaced apart bellows/bearing assemblies 260 (only three are illustrated in FIG. 2). Further, in FIG. 2, each bellows/bearing assembly 260 includes a fluid bellows 262 and a bearing pad 264. In this embodiment, the pressure in the fluid bellows 262 can be controlled to control the weight supported by the fluid bellows assembly 258. Moreover, fluid can be released from the bearing pad 264 towards the stage base 236 to maintain the bearing pad 264 spaced apart along the Z axis from the stage base 236. This allows the bellows/bearing assemblies 260, the connector bar 248, the stage 238, and the work piece 200 to move along the Y axis and about the Z axis relative to the stage base 236. Alternatively, each of the bearing, for example, can be a vacuum preload type fluid bearing, a magnetic type bearing or a roller type assembly.

The control system 224 that directs current to the conductor component 256 of each mover 244, 246 to generate a controllable force for each mover 244, 246 along the Y axis (“first axis”) and a controllable force along the Z axis (“second axis”). The control system 224 is described in more detail below.

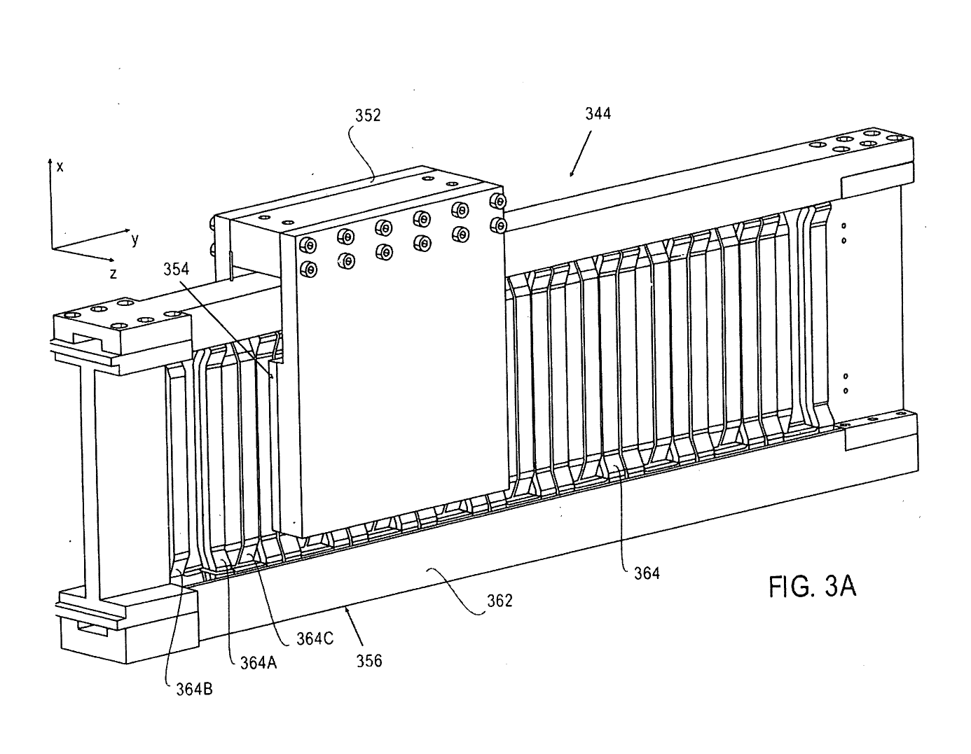

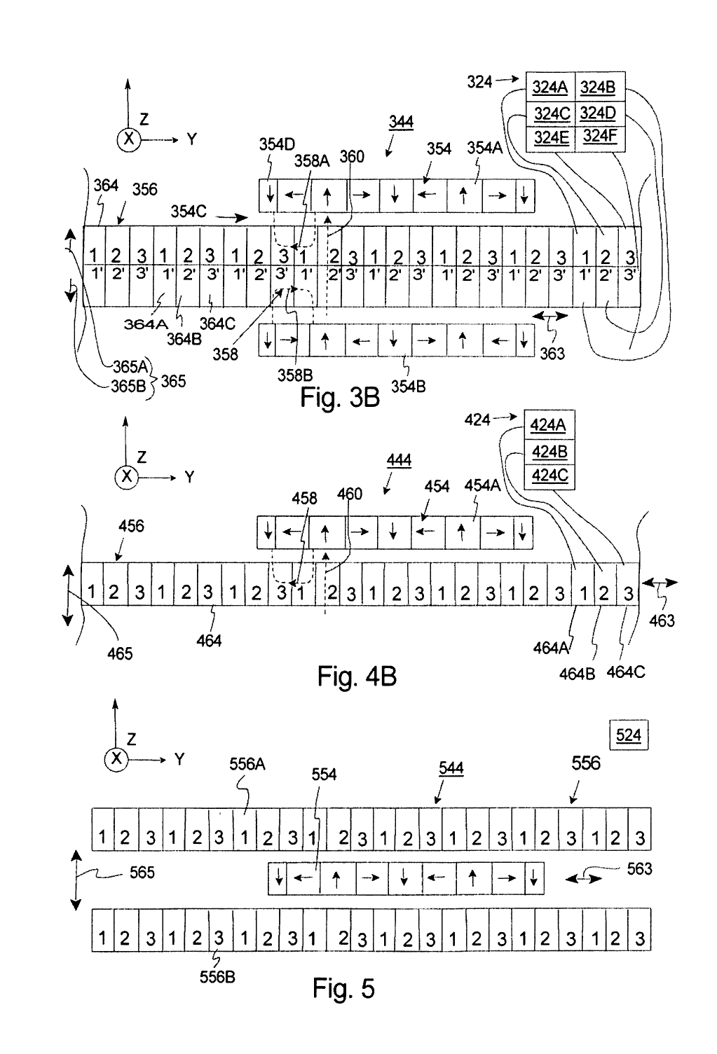

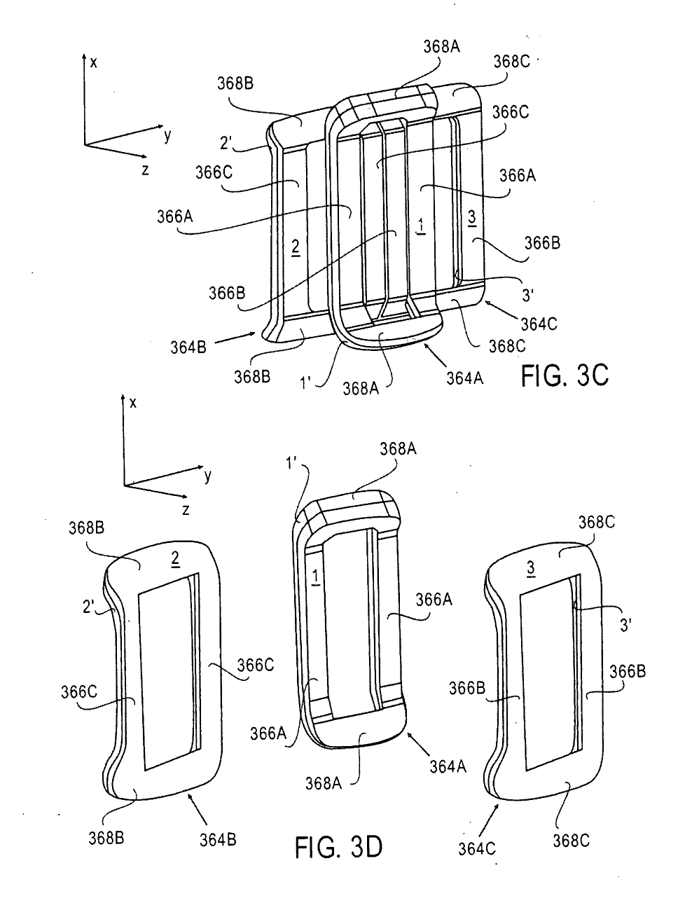

FIG. 3A is a simplified perspective view of one embodiment of a mover 344 that can be used as the first mover 244 or the second mover 246 in FIG. 2, or for another usage. In this embodiment, the mover 344 can be used for moving a stage 238 (illustrated in FIG. 2) along a first axis (the Y axis), and along a second axis (the Z axis). In this embodiment, the mover 344 includes a mover frame 352, a magnetic component 354, and a conductor component 356. Alternatively, the mover 344 can be designed with more or fewer components than that illustrated in FIG. 3.

The mover frame 352 supports some of the components of the mover 344. In one embodiment, the mover frame 352 is generally rigid and shaped somewhat similar to a sideways “U”. The mover frame 352 can be secured to the stage base 236 (illustrated in FIG. 2) or a reaction type assembly. For example, the mover frame 352 can be made of a highly magnetically permeable material, such as a soft iron that provides some shielding of the magnetic fields, as well as providing a low reluctance magnetic flux return path for the magnetic fields of the magnetic component 354.

The magnetic component 354 creates a magnetic field. FIG. 3B is a simplified cut-away view of a portion of the mover 344 of FIG. 3A that illustrates the magnetic component 354 and the conductor component 356 in more detail. In this embodiment, the magnetic component 354 includes a first magnet array 354A and a second magnet array 354B. Further, the magnet arrays 354A, 354B are secured to opposite sides of the mover frame 352 (illustrated in FIG. 3A) and a magnet gap 354C separates the magnet arrays 354A, 354B.

Each of the magnet arrays 354A, 354B includes one or more magnets 354D. The design, the positioning, and the number of magnets 354D in each magnet array 354A, 354B can be varied to suit the design requirements of the mover 344. For example, each magnet array 354A, 354B can include nine (9), rectangular shaped magnets 354D that are aligned side-by-side linearly. Further, in FIG. 3A, the magnets 354D in each magnet array 354A, 354B are orientated so that the poles facing the magnet gap 354C alternate between the North pole, transversely oriented, and the South pole. This type of array is commonly referred to as a Halbach array. Alternatively, each magnet array 354A, 354B can be designed without the transversely oriented magnets. Further, each magnet array 354A, 354B can include more than nine or fewer than nine magnets 354D.

In FIG. 3B, the conductor array 356 is longer along the primary axis of movement (along the Y axis) than each magnet array 354A, 354B; this configuration is usually used in a moving-magnet motor, which is generally preferable in a lithography stage system (because of fewer hoses & wires to the moving stage). Alternatively, however, each magnet array 354A, 354B may be longer than the conductor array 356 along the axis of movement (the Y axis in FIG. 3B); this configuration is typical for a linear motor in which the conductor component 356 moves relative to the magnetic component 354 (a moving-coil motor).

In FIG. 3B, the polarity of the pole facing the magnet gap 354C of each of the magnets 354D in the first magnet array 354A is opposite from the polarity of the pole of the corresponding magnet 354D in the second magnet array 354B. Thus, North poles face South poles across the magnet gap 354C. This leads to strong magnetic fields in the magnet gap 354C and strong force generation capability.

Each of the magnets 354D can be made of a high energy product, rare earth, permanent magnetic material such as NdFeB. Alternately, for example, each magnet 354D can be made of a low energy product, ceramic or other type of material that is surrounded by a magnetic field.

The magnetic orientation of each of the magnets 354D are illustrated in FIG. 3B as solid arrows. In this embodiment, the magnetic component 354 creates a first axis magnetic flux 358 (illustrated as dashed arrows) having portion that is oriented substantially horizontally along the Y axis, and a second axis magnetic flux 360 (also illustrated as dashed arrows) that is oriented vertically along the Z axis (perpendicular to Y axis) across the magnetic gap 354C. The first axis magnetic flux 358 can be separated into an upper, first magnetic flux 358A that is adjacent the first magnet array 354A and a lower first magnetic flux 358B that is adjacent the second magnet array 354B.

It should be noted that because of manufacturing tolerances the upper, first magnetic flux 358A can have a magnitude that is not exactly equal to the magnitude of the lower first magnetic flux 358B, and that the directions of the magnetic flux may deviate somewhat from the desired direction and strength.

As provided herein, electric current that is directed to the conductor component 356 interacts with the magnetic fields that surround the magnet component 354 to generate (i) a Y driving force 363 (illustrated as a two headed arrow) along the Y axis that can move the conductor component 356 along the Y axis, and (ii) a Z driving force 365 (illustrated as arrows) along the Z axis that acts on the conductor component 356 substantially transversely to the Y axis The Z driving force 365 can be separated into an upper driving force 365A that results from a portion of the conductor component 356 being positioned in the upper, first magnetic flux 358A, and a lower driving force 365B that results from a portion of the conductor component 356 being positioned in the lower, first magnetic flux 358B. In FIG. 3B, depending upon the direction of the current in the conductor component 356 and the position of the conductor component 356, the upper driving force 365A can be directed up or down and the lower driving force 365B can be independently directed down or up.

Referring to FIGS. 3A and 3B, the conductor component 356 is positioned near and interacts with the magnet component 354, and is positioned and moves within the magnetic gap 354C. In this embodiment, the conductor component 356 includes a conductor housing 362 (illustrated in FIG. 3A) and a conductor array having one or more conductors 364, e.g. coils that are embedded into the conductor housing 362. In the embodiment illustrated in FIG. 3A, the conductor component 356 includes eighteen coils 364. Further, six of these coils 364 can be labeled as a first phase coils 364A (illustrated with “1” and “1′” in FIG. 3B), six of these coils 364 can be labeled as second phase coils 364B (illustrated with “2” and “2′” in FIG. 3B), and six of these coils 364 can be labeled as third phase coils 364C (illustrated with “3” and “3′” in FIG. 3B) that can define a three phase conductor component 356. In this embodiment, the coils 364 are aligned and staggered along the Y axis. The three phases of the conductor component 356 are generally each 120 degrees out of phase. With this design, the mover 344 can be operated as a three phase AC motor.

In general, the conductor component 356 may include any number of coils 364. Thus, the conductor component 356 can be designed with fewer than eighteen or greater than eighteen coils 364. Stated in another fashion, each phase can include more than six or fewer than six coils 364.

Further, in this embodiment, each of the coils 364 is a split type coil. More specifically, each of the first phase coils 364A is split, each of the second phase coils 364B is split, and each of the third phase coils 364C is split. Stated in another fashion, in FIG. 3B, there is (i) an upper set of first phase coils 364A (illustrated with “1”), (ii) a lower set of first phase coils 364A (illustrated with “1′”) that are positioned below the upper set, (iii) an upper set of second phase coils 364B (illustrated with “2”), (iv) a lower set of second phase coils 364B (illustrated with “2′”) that are positioned below the upper set, (v) an upper set of third phase coils 364C (illustrated with “3”), and (vii) a lower set of third phase coils 364C (illustrated with “3′”) that are positioned below the upper set. In this embodiment, depending on the relative location between the magnet component 354 and the conductor component 356, each upper set 1, 2, 3 can be positioned to interact with the upper first magnetic flux 358A and each lower set 1′, 2′, 3′ can be positioned to interact with the lower first magnetic flux 358B.

FIGS. 3C and 3D illustrate the positioning and design of one first phase coil 364A, one second phase coil 364B, and one third phase coil 364C. FIG. 3C is a perspective view and FIG. 3D is an exploded perspective view of these three coils. As illustrated in FIG. 3C, the phase coils 364A, 364B, 364C overlap each other. In this embodiment, (i) the first phase coil 364A includes a pair of spaced apart first coil legs 366A that extend along the X axis, (ii) the second phase coil 364B includes a pair of spaced apart second coil legs 366B that extend along the X axis, and (iii) the third phase coil 364C includes a pair of spaced apart third coil legs 366C that extend along the X axis. Further, one of the second coil legs 366B and one of the third coil legs 366C are positioned between the first coil legs 366A of a single first phase coil 364A along the Y axis. Similarly, (but not shown in FIG. 3C) one of the second coil legs 366B and one of the first coil legs 366A are positioned between the third coil legs 366C of a single third phase coil 364C along the Y axis, and one of the third coil legs 366C and one of the first coil legs 366A are positioned between the second coil legs 366B of a single second phase coil 364B along the Y axis. Thus, (i) the first phase coils 364A overlap a portion of the second and third phase coils 364B, 364C, (ii) the second phase coils 364B overlap a portion of the first and third phase coils 364A, 364C, and (iii) the third phase coils 364C overlap a portion of the first and second phase coils 364A, 364B.

Moreover, each first phase coil 364A includes a pair of spaced apart first end-turn sections 368A that connect the first coil legs 366A together, each second phase coil 364B includes a pair of spaced apart second end-turn sections 368B that connect the second coil legs 366B together, and each third phase coil 364C includes a pair of spaced apart third end-turn sections 368C that connect the third coil legs 366C together. Moreover, each of the end-turn sections 368A, 368B, 368C are angled out of the plane of the motor (in the Z direction) to allow the coils to overlap each other. In the embodiment shown in FIGS. 3A, 3C, and 3D, half of the coils have end-turns bent in the +Z direction, and half have end-turns bent in the −Z direction. Bending the end-turns in the Z direction allows for portions of the coils 364 to be overlapping. Overlapping the coils in this way provides two benefits: the force-generating coil legs 366A, 366B, 366C can be densely packed together with minimal empty space, and the width of each coil leg 366A, 366B, 366C can be reduced. Both of these factors increase the efficiency of the mover.

FIGS. 3C and 3D also illustrate the split coil design of one first phase coil 364A, one second phase coil 364B, and one third phase coil 364C. In these Figures, (i) the upper first phase coil 364A is designated with a “1”, (ii) the lower first phase coil 364A is designated with “1′”, (iii) the upper second phase coil 364B is designated with “2”, (iv) the lower second phase coil 364B is designated with “2′”, (v) the upper third phase coil 364C is designated with “3”, and (vii) the lower third phase coil 364C is represented with “3′”.

Referring back to FIG. 3B, the control system 324 directs current to the coils 364 to generate the controllable Y driving force 363 and the controllable Z driving force 365 to position one of the components 356, 354 relative to the other component 354, 356. In this embodiment, the control system 324 independently directs and controls the current to (i) the upper set of first phase coils 364A, (ii) the lower set of first phase coils 364A, (iii) the upper set of second phase coils 364B, (iv) the lower set of second phase coils 364B, (v) the upper set of third phase coils 364C, and (vii) the lower set of third phase coils 364C. As provided herein, separate current supplies are generally needed for the each upper set, and each lower set for each phase coils 364A, 364B, 364C. Further, as the mover 344 moves, the directions in which current is applied to the each upper set, and each lower set for each phase coils 364A, 364B, 364C may vary due to commutation.

More specifically, FIG. 3B includes a schematic representation of the control system 324 with substantially separate current supplies in accordance with an embodiment of the present invention. In this embodiment, the control system 324 includes (i) an upper first current supply 324A that directs current to the upper set of first phase coils 364A, (ii) a lower first current supply 324B that directs current to the lower set of first phase coils 364A, (iii) an upper second current supply 324C that directs current to the upper set of second phase coils 364B, (iv) a lower second current supply 324D that directs current to the lower set of second phase coils 364B, (v) an upper third current supply 324E that directs current to the upper set of third phase coils 364C, and (vii) a lower third current supply 324F that directs current to the lower set of third phase coils 364C. As provided herein, each of the current supplies 324A-324F can include a current amplifier (not shown), and can be controlled by a current command (not shown).

When electric currents flow in the coils 364A, 364B, 364C, Lorentz type forces are generated in a direction mutually perpendicular to the direction of the wires of the coils 364A, 364B, 364C and the magnetic fields in the magnetic gap 354C. If the current magnitudes and polarities are adjusted properly to the alternating polarity of the magnet fields in the magnetic gap 354C, the controllable Y driving force 363 can be generated and the controllable Z driving force 365 can be generated. With this design, the movement of the conductor component 356 can be controlled along two axes, namely the Y axis and the Z axis.

As provided herein, with this design, the controllable Y force 363 can be generated by (i) directing the appropriate current to the first phase coils 364A when the first coil legs 366A are positioned in the second magnetic flux 360, (ii) directing the appropriate current to the second phase coils 364B when the second coil legs 366B are positioned in the second magnetic flux 360, and/or (iii) directing the appropriate current to the third phase coils 364C when the third coil legs 366C are positioned in the second magnetic flux 360. Further, the controllable Z force 365 can be generated by (i) directing the appropriate current to the first phase coils 364A when the first coil legs 366A are positioned in the first magnetic flux 358, (ii) directing the appropriate current to the second phase coils 364B when the second coil legs 366B are positioned in the first magnetic flux 358, and/or (iii) directing the appropriate current to the third phase coils 364C when the third coil legs 366C are positioned in the first magnetic flux 358.

With the split coil design, when a portion of the first coils legs 366A of the upper set of first phase coils 364A are positioned in the upper first magnetic flux 358A, then a similar portion of the first coil legs 366A of the lower set of first phase coils 364A are positioned in the lower first magnetic flux 358B. Somewhat similarly, when a portion of the second coils legs 366B of the upper set of second phase coils 364B are positioned in the upper first magnetic flux 358A, then a similar portion of the second coil legs 366B of the lower set of second phase coils 364B are positioned in the lower first magnetic flux 358B. Further, when a portion of the third coils legs 366C of the upper set of third phase coils 364C are positioned in the upper first magnetic flux 358A, then a similar portion of the third coil legs 366C of the lower set of third phase coils 364C are positioned in the lower first magnetic flux 358B. Thus, for each phase coil 364A, 364B, 364C, when subjected to the first magnetic flux 358, the respective coil legs 366A, 366B, 366C of the upper set is positioned in an opposite magnetic field than the respective coil legs 366A, 366B, 366C of the lower set.

With this design, for example, if current is directed to both sets of first phase coils 364A in opposite directions and with the same magnitude when the first coil legs 366A are subjected to the first axis magnetic flux 358, the first phase coils 364A will generate the upper Z driving force 365A and the lower Z driving force 365B that will both act in the same direction (not as illustrated in FIG. 3B). At the same time, any Y direction forces generated by the upper and lower sets of the first phase coils 364A will cancel out if the upper first magnetic flux 358A and the lower first magnetic flux 358B are equal magnitude in opposing directions. Alternatively, if current is directed to the sets of first phase coils 364A in different directions and/or with the different magnitudes, the first phase coils 364A will generate net forces in both the Z and Y directions. Directing current to the other phase coils 364B, 364C in a similar fashion at the appropriate time will cause the other phase coils 364B, 364C to generate the controllable Z force 365.

To produce force in the Y direction, coils that are positioned to interact with the second magnetic flux 360 are energized. For example, as shown in FIG. 3B, the upper and lower sets of the second phase coils 364B can be energized with electric currents of the same magnitude and polarity. In this way, both the upper and lower sets will generate force in the same Y direction, and any Z forces produced by the upper and lower sets of coils will cancel.

In this embodiment, the control system 324 can independently direct current to (i) the upper set of first phase coils 364A, (ii) the lower set of first phase coils 364A, (iii) the upper set of second phase coils 364B, (iv) the lower set of second phase coils 364B, (v) the upper set of third phase coils 364C, and (vi) the lower set of third phase coils 364C to generate the desired Y driving force 363 and the desired Z driving force 365. Regarding each set of each phase, the current can be (i) in the same direction and have the same magnitude, (ii) in the same direction and with different magnitudes, (iii) in the different directions and have the same magnitude, or (iv) in the different directions and with different magnitudes.

In other words, when the relative motion between a split coil and a magnet is relatively large, portions of the split coils may effectively flip between being used to apply a non-zero net force along the Y axis and being used to apply a substantially non-zero net force along the Z axis. By varying the direction in which current is applied to the upper set and the lower set of a portion of a split coil, the direction of the net force applied by the portion may be varied.

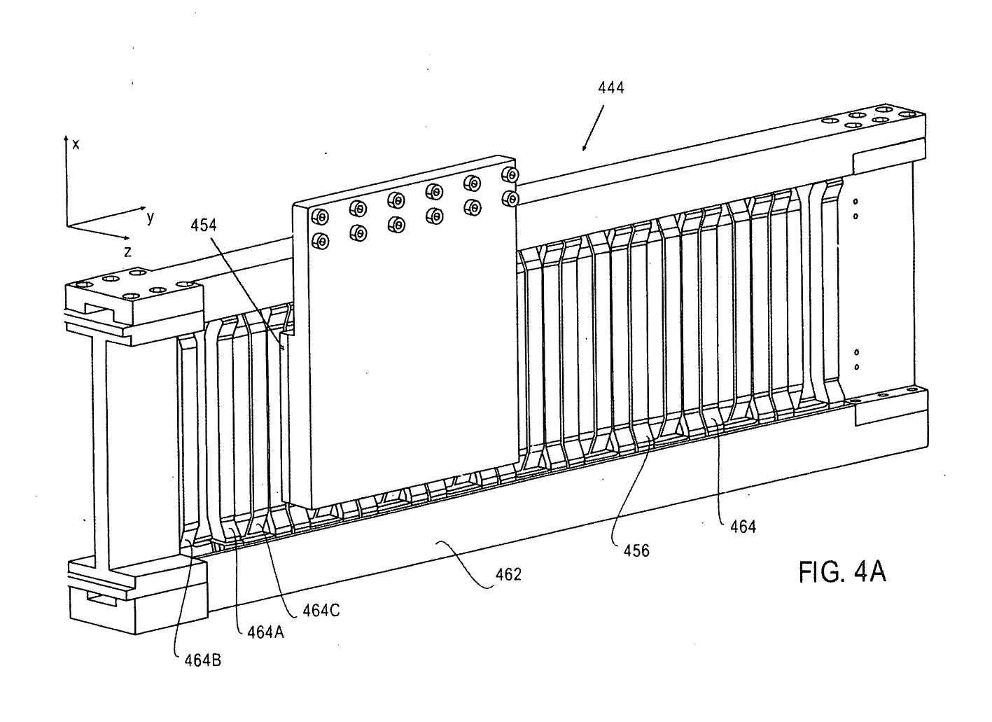

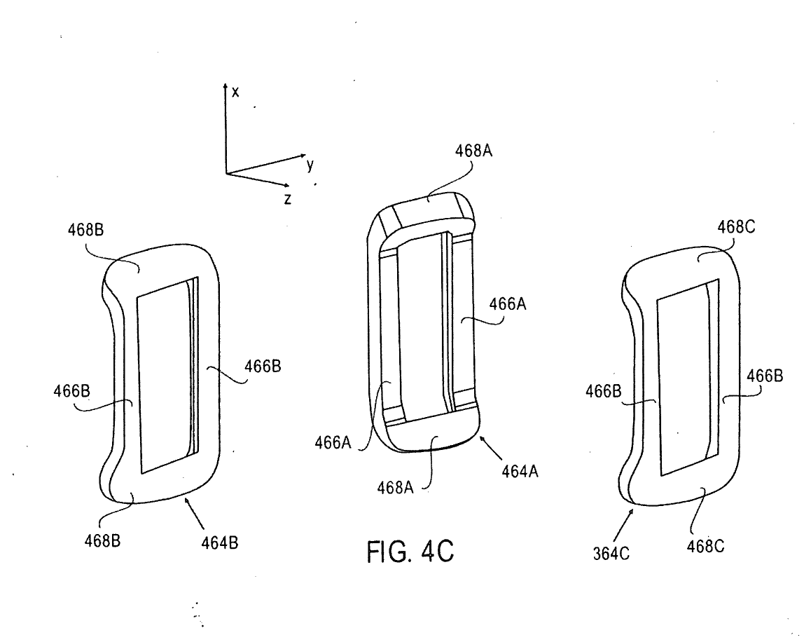

FIG. 4A is a simplified perspective illustration and FIG. 4B is a simplified cut-away view of another embodiment of a portion of a mover 444 that can be used as the first mover 244 or the second mover 246 in FIG. 2, or for another usage. In this embodiment, the mover 44 can be used to move a stage along two axes, namely along the Y axis and along the Z axis.

In this embodiment, the mover 444 again includes a magnetic component 454 and a conductor component 456. However, in this embodiment, the magnetic component 454 includes only a single magnet array 454A that is similar to the magnet arrays 354A, 354B described above.

Further, in this embodiment, the conductor component 456 is again positioned near and interacts with the magnet component 454. In this embodiment, the conductor component 456 includes a conductor housing 462 and a conductor array having one or more conductors 464, e.g. coils that are embedded into the conductor housing 462. In the embodiment illustrated in FIG. 4A, the conductor component 456 again includes eighteen coils 464. Further, six of these coils 464 can be labeled as a first phase coils 464A (illustrated with “1” in FIG. 3B), six of these coils 464 can be labeled as second phase coils 464B (illustrated with “2” in FIG. 3B), and six of these coils 464 can be labeled as third phase coils 464C (illustrated with “3”) that can define a three phase conductor component 456. In this embodiment, the coils 464 are again aligned and staggered along the Y axis. Further, the three phases of the conductor component 456 are generally each 120 degrees out of phase. With this design, the mover 444 can be operated as a three phase AC motor.

In this embodiment, the coils 464 are similar in shape to the coils 364 described above, however, in this embodiment, the coils 464 are not split.

FIG. 4C illustrates the design one first phase coil 464A, one second phase coil 464B, and one third phase coil 464C. In this embodiment, (i) the first phase coil 464A includes a pair of spaced apart first coil legs 466A that extend along the X axis, (ii) the second phase coil 464B includes a pair of spaced apart second coil legs 466B that extend along the X axis, and (iii) the third phase coil 464C includes a pair of spaced apart third coil legs 466C that extend along the X axis. Further, one of the second coil legs 466B and one of the third coil legs 466C are positioned between the first coil legs 466A of a single first phase coil 464A along the Y axis. With this design, the second phase coils 464B and the third phase coils 464C overlap the first phase coils 464A.

Moreover, each first phase coil 464A includes a pair of spaced apart first end-turn sections 468A that connect the first coil legs 466A together, each second phase coil 464B includes a pair of spaced apart second end-turn sections 468B that connect the second coil legs 466B together, and each third phase coil 464C includes a pair of spaced apart third end-turn sections 468C that connect the third coil legs 466C together. Moreover, each of the transverse sections 468A, 468B, 468C are angled relative to the X axis. Moreover, each of the end-turn sections 468A, 468B, 468C are angled out of the plane of the motor (in the Z direction) to allow the coils to overlap each other. In this embodiment, half of the coils have end-turns bent in the +Z direction, and half have end-turns bent in the −Z direction. Bending the end-turns in the Z direction allows for portions of the coils 464 to be overlapping. Overlapping the coils in this way provides two benefits: the force-generating coil legs 466A, 466B, 466C can be packed together with minimal empty space, and the width of each coil leg 466A, 466B, 466C can be reduced. Both of these factors increase the efficiency of the mover.

Referring back to FIG. 4B, the control system 424 directs current to the coils 464 to generate the controllable Y driving force 463 and the controllable Z driving force 465 to position one of the components 456, 454 relative to the other component 454, 456. In this embodiment, the control system 424 independently directs and controls the current to (i) the first phase coils 464A, (ii) the second phase coils 464B, and (iii) the third phase coils 464C.

More specifically, FIG. 4B includes a schematic representation of the control system 424 with substantially separate current supplies in accordance with an embodiment of the present invention. In this embodiment, the control system 424 includes (i) a first current supply 424A that directs current to the first phase coils 464A, (ii) a second current supply 424B that directs current to the second phase coils 464B, and (iii) a third second current supply 424C that directs current to the third phase coils 464C.

When electric currents flow in the coils 464A, 464B, 464C, Lorentz type forces are generated in a direction mutually perpendicular to the direction of the wires of the coils 464A, 464B, 464C and the magnetic fields. If the current magnitudes and polarities are adjusted properly to the alternating polarity of the magnet fields, the controllable Y driving force 463 can be generated and the controllable Z driving force 465 can be generated. With this design, the movement of the conductor component 456 can be controlled along two axes, namely the Y axis and the Z axis.

As provided herein, with this design, the controllable Y force 463 can be generated by (i) directing the appropriate current to the first phase coils 464A when the first coil legs 466A are positioned in the second magnetic flux 460, (ii) directing the appropriate current to the second phase coils 464B when the second coil legs 466B are positioned in the second magnetic flux 460, and/or (iii) directing the appropriate current to the third phase coils 464C when the third coil legs 466C are positioned in the second magnetic flux 460. Further, the controllable Z force 465 can be generated by (i) directing the appropriate current to the first phase coils 464A when the first coil legs 466A are positioned in the first magnetic flux 458, (ii) directing the appropriate current to the second phase coils 464B when the second coil legs 466B are positioned in the first magnetic flux 458, and/or (iii) directing the appropriate current to the third phase coils 464C when the third coil legs 466C are positioned in the first magnetic flux 458. With this design, if current is directed to the coils 464 in the appropriate fashion, the mover 444 can generate the controllable Y driving force 463 and the controllable Z driving force 465.

FIG. 5 is a simplified cut-away view of a portion of another mover 544 that is similar to the embodiments described above. However, in this embodiment, (i) the conductor component 556 includes an upper conductor component 556A and a lower conductor component 556B that are each somewhat similar to the conductor component 456 illustrated in FIG. 4B and described above, (ii) the magnetic component 554 is positioned between and moves relative to the conductor components 556A, 556B, and (iii) the control system 524 directs current to the conductor components 556A, 556B to generate a controllable Y driving force 563 and a controllable Z driving force 565.

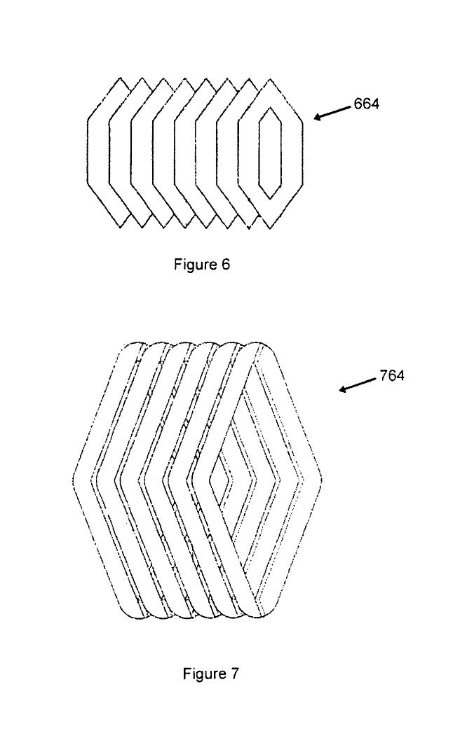

It should be noted that the overlapping conductors can have a different shape than described above. For example, FIG. 6 is a side view of a plurality of hexagonal shaped overlapping conductors 664 that can be used in movers 344, 444, 544 described above. For example, if the conductors 664 are used in the mover 344, the conductors 664 will need to have a split coil design. A more complete description of the overlapping conductors 664 illustrated in FIG. 6 is provided in U.S. Pat. No. 6,355,993. As far as permitted, the contents of U.S. Pat. No. 6,355,993 are incorporated herein by reference.

Further, FIG. 7 is a perspective view of a plurality of diamond shaped conductors 764 that can be used in movers 344, 444, 544 described above. For example, if the conductors 764 are used in the mover 344, the conductors 764 will need to have a split coil design. A more complete description of the overlapping conductors 764 illustrated in FIG. 7 is provided in U.S. Pat. No. 6,373,153. As far as permitted, the contents of U.S. Pat. No. 6,373,153 are incorporated herein by reference.

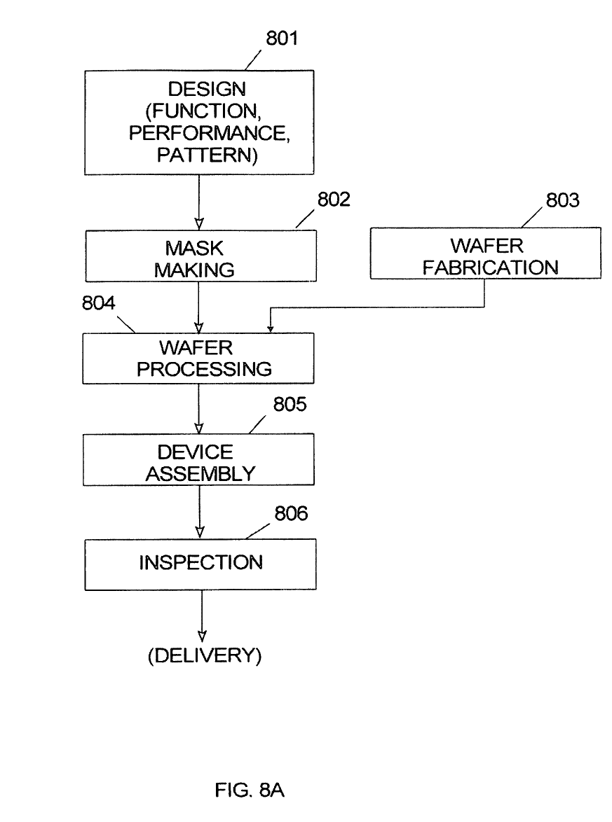

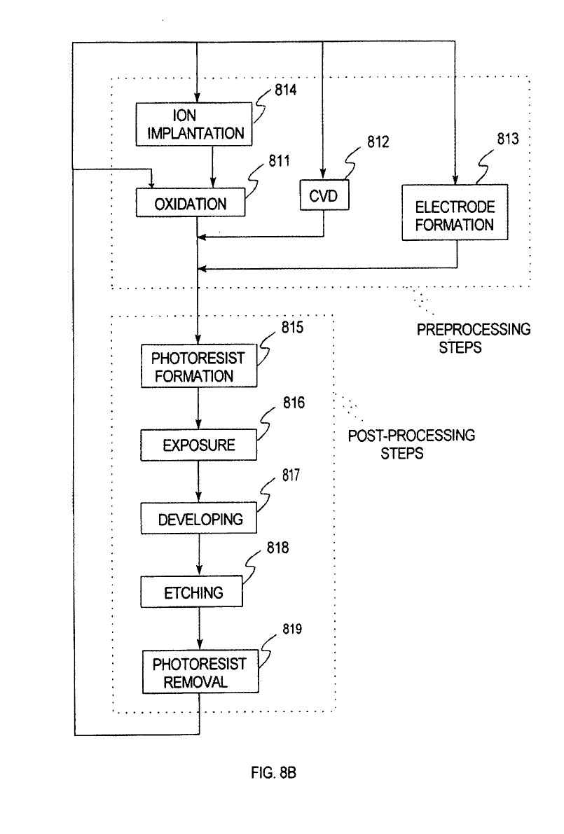

Semiconductor devices can be fabricated using the above described systems, by the process shown generally in FIG. 8A. In step 801 the device's function and performance characteristics are designed. Next, in step 802, a mask (reticle) having a pattern is designed according to the previous designing step, and in a parallel step 803 a wafer is made from a silicon material. The mask pattern designed in step 802 is exposed onto the wafer from step 803 in step 804 by a photolithography system described hereinabove in accordance with the present invention. In step 805, the semiconductor device is assembled (including the dicing process, bonding process and packaging process), finally, the device is then inspected in step 806.

FIG. 8B illustrates a detailed flowchart example of the above-mentioned step 804 in the case of fabricating semiconductor devices. In FIG. 8B, in step 811 (oxidation step), the wafer surface is oxidized. In step 812 (CVD step), an insulation film is formed on the wafer surface. In step 813 (electrode formation step), electrodes are formed on the wafer by vapor deposition. In step 814 (ion implantation step), ions are implanted in the wafer. The above mentioned steps 811-814 form the preprocessing steps for wafers during wafer processing, and selection is made at each step according to processing requirements.

At each stage of wafer processing, when the above-mentioned preprocessing steps have been completed, the following post-processing steps are implemented. During post-processing, first, in step 815 (photoresist formation step), photoresist is applied to a wafer. Next, in step 816 (exposure step), the above-mentioned exposure device is used to transfer the circuit pattern of a mask (reticle) to a wafer. Then in step 817 (developing step), the exposed wafer is developed, and in step 818 (etching step), parts other than residual photoresist (exposed material surface) are removed by etching. In step 819 (photoresist removal step), unnecessary photoresist remaining after etching is removed. Multiple circuit patterns are formed by repetition of these preprocessing and post-processing steps.

While the particular mover as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A mover assembly for moving a stage along a first axis and along a second axis, the mover assembly comprising:
a magnetic component including a magnet that is surrounded by a magnetic field;
a conductor component that is positioned near the magnetic component and that interacting with the magnetic component when current is directed to the conductor component, the conductor component including a first phase coil and a second phase coil that partly overlaps the first phase coil; and
a control system that directs current to the conductor component to generate a controllable force along the first axis and a controllable force along the second axis.

2. The mover assembly of claim 1 wherein the first phase coil includes a pair of spaced apart first coil legs, and the second phase coil includes a pair of spaced apart second coil legs; wherein one of the first coil legs is positioned between second coil legs.

3. The mover assembly of claim 1 wherein the coil assembly includes a third phase coil that partly overlaps the first phase coil and the second phase coil.

4. The mover assembly of claim 3 wherein the first phase coil includes a pair of spaced apart first coil legs, the second phase coil includes a pair of spaced apart second coil legs, and the third phase coil includes a pair of spaced apart third coil legs; wherein one of the second coil legs and one of the third coil legs are positioned between first coil legs.

5. The mover assembly of claim 4 wherein each of the phase coils is a split coil design.

6. The mover assembly of claim 5 wherein the magnetic component includes a pair of spaced apart magnet arrays and wherein the conductor component is positioned between the magnet arrays.

7. The mover assembly of claim 4 wherein the magnetic component includes a single magnet array that is positioned on one side of the conductor component.

8. The mover assembly of claim 5 wherein the magnetic component includes a pair of spaced apart conductor arrays and wherein the magnetic component is positioned between the conductor arrays.

9. A stage assembly that moves a device, the stage assembly including a stage that retains the device and the mover assembly of claim 1 that moves the stage along the first axis and along the second axis.

10. An exposure apparatus including an illumination system and the stage assembly of claim 9 that moves the stage relative to the illumination system.

11. A process for manufacturing a device that includes the steps of providing a substrate and forming an image to the substrate with the exposure apparatus of claim 10.

12. A mover assembly for moving a stage along a first axis and along a second axis, the mover assembly comprising:
a magnetic component including a magnet that is surrounded by a magnetic field;
a conductor component that is positioned near the magnetic component and that interacting with the magnetic component when current is directed to the conductor component, the conductor component including a first phase coil, a second phase coil, and a third phase coil; wherein the first phase coil includes a pair of spaced apart first coil legs, the second phase coil includes a pair of spaced apart second coil legs, and the third phase coil includes a pair of spaced apart third coil legs; wherein one of the second coil legs and one of the third coil legs are positioned between first coil legs along first axis; and
a control system that directs current to the conductor component to generate a controllable force along the first axis and a controllable force along the second axis.

13. The mover assembly of claim 12 wherein each of the phase coils is a split coil design.

14. The mover assembly of claim 13 wherein the magnetic component includes a pair of spaced apart magnet arrays and wherein the conductor component is positioned between the magnet arrays.

15. The mover assembly of claim 12 wherein the magnetic component includes a single magnet array that is positioned on one side of the conductor component.

16. A stage assembly that moves a device, the stage assembly including a stage that retains the device and the mover assembly of claim 12 that moves the stage along the first axis and along the second axis.

17. An exposure apparatus including an illumination system and the stage assembly of claim 12 that moves the stage relative to the illumination system.

18. A process for manufacturing a device that includes the steps of providing a substrate and forming an image to the substrate with the exposure apparatus of claim 17.

19. A method for moving a device along a first axis and along a second axis, the method comprising the steps of:
coupling the device to a stage;
coupling a mover the stage, the mover including a magnetic component having a plurality of magnets that are surrounded by a magnetic field, and a conductor component that is positioned near the magnetic component, the conductor component interacting with the magnetic component when current is directed to the conductor component, the conductor component including a first phase coil and a second phase coil that partly overlaps the first phase coil; and
directing current to the conductor component with a control system to generate a controllable force along the first axis and a controllable force along the second axis.

20. The method of claim 19 wherein the first phase coil includes a pair of spaced apart first coil legs, and the second phase coil includes a pair of spaced apart second coil legs; wherein one of the first coil legs is positioned between second coil legs.

21. The method of claim 20 wherein the coil assembly includes a third phase coil that partly overlaps the first phase coil and the second phase coil.

22. The method of claim 21 wherein the first phase coil includes a pair of spaced apart first coil legs, the second phase coil includes a pair of spaced apart second coil legs, and the third phase coil includes a pair of spaced apart third coil legs; wherein one of the second coil legs and one of the third coil legs are positioned between first coil legs.

23. The method of claim 22 wherein each of the phase coils is a split coil design.

24. The method of claim 23 wherein the magnetic component includes a pair of spaced apart magnet arrays and wherein the conductor component is positioned between the magnet arrays.

25. The method of claim 22 wherein the magnetic component includes a single magnet array that is positioned on one side of the conductor component.

26. A method for making an exposure apparatus comprising the steps of providing an illumination source, providing a device, and moving the device by the method of claim 19.

27. A method of making a wafer including the steps of providing a substrate and forming an image on the substrate with the exposure apparatus made by the method of claim 26.
